(19) United States
(12) Patent Application Publication
(10) Pub. No.: US 2016/0105774 A1
(43) Pub. Date: Apr. 14, 2016

(54) TRANSMISSION CANCELLATION METHOD AND TRANSMISSION METHOD

(71) Applicant: KABUSHIKI KAISHA TOSHIBA, Tokyo (JP)

(72) Inventors: Yusuke DOI, Yokohama (JP); Yoshihiro Oba, Kawasaki (JP)

(21) Appl. No.: 14/876,013

(22) Filed: Oct. 6, 2015

(30) Foreign Application Priority Data
Oct. 10, 2014 (JP) 2014-209219

(51) Int. Cl. H04W 4/06; H04W 76/06; H04W 72/04

(52) U.S. Cl. CPC H04W 4/06; H04W 72/0446; H04W 76/068

(57) ABSTRACT

According to an embodiment, a transmission cancellation method includes setting, when a broadcast message is received, a waiting time randomized within a predetermined interval; reserving, in a case where a message which is deemed to be the same as the received message is not received for a predetermined number of times until the waiting time passes, transmission of the message by broadcasting, but not reserving, in a case where the message is received for the predetermined number of times, the transmission of the message by broadcasting; and cancelling the transmission of the message of which transmission is received, in a case where the message of which transmission is reserved is broadcast with timing of a broadcast time slot and a message which is deemed to be the same as the message of which transmission is reserved is received for the predetermined number of times.

### CROSS-REFERENCE TO RELATED APPLICATION(S)

This application is based upon and claims the benefit of priority from Japanese Patent Application No. 2014-209219, filed on Oct. 10, 2014; the entire contents of which are incorporated herein by reference.

### FIELD

Embodiments described herein relate generally to a transmission cancellation method and a transmission method.

### BACKGROUND

In a short distance wireless communication such as ZigBee (registered trademark), in order to transfer a message on a wireless mesh network constituted by multiple nodes (wireless communication terminals), any given node may wirelessly broadcast a message, and another node having received the message may wirelessly broadcast the message again.

In this case, in order to avoid transmission of an unnecessary message, e.g., wireless retransmission of the same message to an area to which the message has already been wirelessly transmitted (transferred), a technique called Trickle Multicast is proposed in RFC6206.

In the Trickle Multicast technique, when a node receives a broadcast message, the node sets an interval t. Subsequently, when the node receives a message consistent with the received message k (k≧1) times before a waiting time s within a period of time of the interval t, then the transmission (transfer) of the received message is cancelled; but when the node receives the message less than k times, the received message is transmitted. The waiting time s is determined randomly within the period of time from t/2 to t (for example, see JP-A 2009-212978 (KOKAI)).

According to the Trickle Multicast, the message transmission (transfer) timing of each node is determined randomly. Therefore, collision of the transmission (transfer) of the message is avoided, and a node that does not satisfy the transmission condition does not transmit the message, so that transmission of unnecessary messages can be avoided.

Here, TSCH (Time-Slotted Channel Hopping) defined in IEEE 802.15.4e is considered to be applied to the Trickle Multicast.

In the TSCH, the broadcast is specified to be performed in a broadcast time slot allocated with a Multicast channel, and therefore, the broad cast of the message is not performed after the elapse of the waiting time s, but is performed in the broadcast time slot immediately after the waiting time s.

More specifically, the message transmission (transfer) timing of each node is quantized in units of the broadcast time slots, and therefore, the collision of the transmission of the message occurs frequently, and the transmission of unnecessary messages also occurs.

### BRIEF DESCRIPTION OF THE DRAWINGS

FIG. 1 is a configuration diagram illustrating an example of a node according to a first embodiment;

FIG. 2 is an explanatory diagram illustrating an example of a transmission cancellation of a message according to the first embodiment;

FIG. 3 is an explanatory diagram illustrating an example of a transmission cancellation of the message according to the first embodiment;

FIG. 4 is an explanatory diagram illustrating an example of a transmission cancellation of the message according to the first embodiment;

FIG. 5 is an explanatory diagram illustrating an example of a transmission cancellation of the message according to the first embodiment;

FIG. 6 is an explanatory diagram illustrating an example of a transmission cancellation of the message according to the first embodiment;

FIG. 7 is an explanatory diagram illustrating an example of a transmission cancellation of the message according to the first embodiment;

FIG. 8 is an explanatory diagram illustrating an example of a transmission cancellation of the message according to the first embodiment;

FIG. 9 is an explanatory diagram illustrating an example of a transmission cancellation of the message according to the first embodiment;

FIG. 10 is an explanatory diagram illustrating an example of a transmission cancellation of the message according to the first embodiment;

FIG. 11 is an explanatory diagram illustrating an example of a transmission cancellation of the message according to the first embodiment;

FIG. 12 is an explanatory diagram illustrating an example of a transmission cancellation of the message according to the first embodiment;

FIG. 13 is an explanatory diagram illustrating an example of a transmission cancellation of the message according to the first embodiment;

FIG. 14 is an explanatory diagram illustrating an example of a transmission cancellation of the message according to the first embodiment;

FIG. 15 is an explanatory diagram illustrating an example of a transmission cancellation of the message according to the first embodiment;

FIG. 16 is an explanatory diagram illustrating an example of a transmission cancellation of the message according to the first embodiment;

FIG. 17 is an explanatory diagram illustrating an example of a transmission cancellation of the message according to the first embodiment;

FIG. 18 is an explanatory diagram illustrating an example of a transmission cancellation of the message according to the first embodiment;

FIG. 19 is an explanatory diagram illustrating an example of a transmission cancellation of the message according to the first embodiment;

FIG. 20 is an explanatory diagram illustrating an example of a transmission cancellation of the message according to the first embodiment;

FIG. 21 is an explanatory diagram illustrating an example of a transmission cancellation of the message according to the first embodiment;

FIG. 22 is a flowchart illustrating a processing example of a node according to the first embodiment;

FIG. 23 is a configuration diagram illustrating an example of a node according to a second embodiment;

FIG. 24 is a flowchart illustrating a processing example of a first manager of the node according to the second embodiment;

FIG. 25 is a flowchart illustrating a processing example of a second manager of the node according to the second embodiment; and

FIG. 26 is a figure illustrating an example of a hardware configuration of a node according to each embodiment.

### DETAILED DESCRIPTION

According to an embodiment, a transmission cancellation method includes setting, when a broadcast message is received, a waiting time randomized within a predetermined interval; reserving, in a case where a message which is deemed to be the same as the received message is not received for a predetermined number of times until the waiting time passes, transmission of the message by broadcasting, but not reserving, in a case where the message is received for the predetermined number of times, the transmission of the message by broadcasting; and cancelling the transmission of the message of which transmission is received, in a case where the message of which transmission is reserved is broadcast with timing of a broadcast time slot and a message which is deemed to be the same as the message of which transmission is reserved is received for the predetermined number of times.

Hereinafter, various embodiments will be described in details with reference to appended drawings.

### First Embodiment

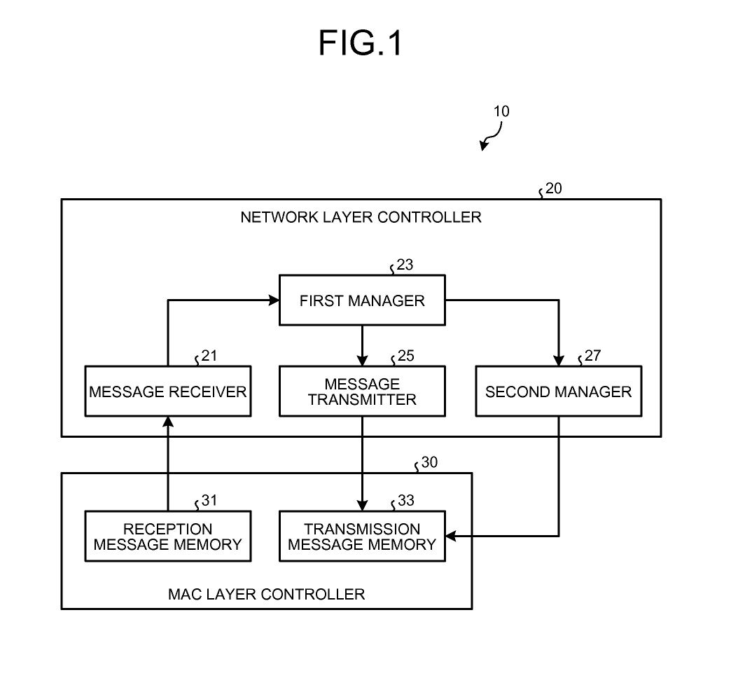

FIG. 1 is a configuration diagram illustrating an example of a node 10 according to a first embodiment. The node 10 is a wireless communication terminal capable of short distance wireless communication such as ZigBee (registered trademark), and includes a NETWORK layer controller 20 and a MAC layer controller 30 as shown in FIG. 1.

In the first embodiment, the node 10 will be described mainly with regard to the control for performing the Trickle Multicast proposed in RFC6206. The Trickle Multicast is used for an instruction given to the entire wireless mesh network constituted by multiple nodes including the node 10 and in a case where a firmware is updated.

The NETWORK layer controller 20 is configured to control a short distance wireless communication defined in the NETWORK layer. The NETWORK layer controller 20 can be achieved by, for example, causing a processing device such as a CPU (Central Processing Unit) to execute a program, and more specifically, it can be achieved by software.

In the first embodiment, a control of a Trickle Forwarder for performing the Trickle Multicast proposed in RFC6206 will be mainly described to detail the control performed by the NETWORK layer controller 20.

The NETWORK layer controller 20 includes a message receiver 21, a first manager 23, a message transmitter 25, and a second manager 27.

The MAC layer controller 30 is configured to control a short distance wireless communication defined in the MAC layer, and can be achieved by, for example, hardware such as a wireless communication chip.

More particularly, the MAC layer controller 30 according to the first embodiment manages the MAC layer by the time division multiplex in accordance with Time-Slotted Channel Hopping (TSCH) proposed in IEEE 802.15.4e. More specifically, the MAC layer controller 30 is to transmit a message, which is instructed by the NETWORK layer controller 20 to transmit, in a time slot with particular timing.

The MAC layer controller 30 also includes a reception message memory 31 and a transmission message memory 33.

The reception message memory 31 is a buffer storing (memorizing) a message wirelessly transmitted from another node (reception message).

The message receiver 21 receives a message stored in the reception message memory 31. When the received message is a message supporting the Trickle Multicast (for example, a message that is broadcast from another node), the message receiver 21 sends the message to the first manager 23. A case where the received message is a message not supporting the Trickle Multicast, description thereof is omitted because such case is not within the gist of the present embodiment.

The first manager 23 is configured to performing management for performing the Trickle Multicast, and more particularly, the first manager 23 performs the same processing as the processing defined in RFC6206 section 4.2.

For example, when the first manager 23 receives a message from the message receiver 21, the first manager 23 sets the interval t if it is not set and randomly determines a waiting time s within a period of time from t/2 to t. Then, when the first manager 23 does not receive a message consistent with the received message from the message receiver 21 for k times before the waiting time s, the first manager 23 instructs the message transmitter 25 to transmit the first received message (a message that triggered the setting of the interval t). On the other hand, when the first manager 23 receives a message consistent with the received message from the message receiver 21 for k times before the waiting time s, the first manager 23 does not instruct the message transmitter 25 to transmit the first received message (a message that triggered the setting of the interval t).

The message consistent with the received message is a message deemed to be the same as the received message, and examples of the message consistent with the received message include the same message as the received message and a message having the same ID as that of the received message. More particularly, the message consistent with the received message is defined as implementation dependent in RFC6206. For example, IETF Internet-Draft draft-ietf-roll-trickle-mcast-09 defines conditions of a consistent message in sections 9.2 and 10.2.

The message transmitter 25 stores (memorizes) the message, which is instructed by the first manager 23 to transmit, to the transmission message memory 33. Thereby, the transmission of the message, which is instructed by the first manager 23 to transmit, is reserved.

The transmission message memory 33 is a buffer for holding messages in a queue format. The MAC layer controller 30 wirelessly broadcasts a transmission target message (a broadcast message of which transmission is reserved at the earliest point in time series) at a broadcast time slot. More specifically, in the first embodiment, the message is not broadcast at the timing when the transmission of the message is reserved, and instead, the message is broadcast in a next broadcast time slot after the transmission has been reserved.

The second manager 27 manages the message which the first manager 23 has instructed the message transmitter 25 to transmit, deletes a message satisfying any one of the following conditions (1) to (3) from the transmission message memory 33, and cancels the transmission of the message. In the first embodiment, when the condition (1) is satisfied, the second manager 27 deletes the message which is reserved to be transmitted at a later point in time series. However, the first embodiment is not limited thereto, and any message may be deleted.

(1) A case where the same message is included in the transmission message memory 33.

(2) A case where the first manager 23 receives a message consistent with the message stored in the transmission message memory 33 from the message receiver 21 for k times until the interval t passes.

(3) A case where the first manager 23 receives a message newer than the message stored in the transmission message memory 33 from the message receiver 21 until the interval t passes.

For example, when the transmission message memory 33 stores a message, the transmission message memory 33 returns a queue ID of a queue to which the message is stored (entered) back to the second manager 27. When there is a message that satisfies any one of the conditions (1) to (3), the second manager 27 notifies the transmission message memory 33 of the queue ID of the message, and deletes the message. However, the instruction of the deletion target message is not limited to the queue ID, and alternatively, a pointer, a message ID, and the like may also be used. In the condition (3), determination as to whether a message is newer than the message stored in the transmission message memory 33 can be made, for example, by incorporating, into the message, information for determining which is newer such as a version.

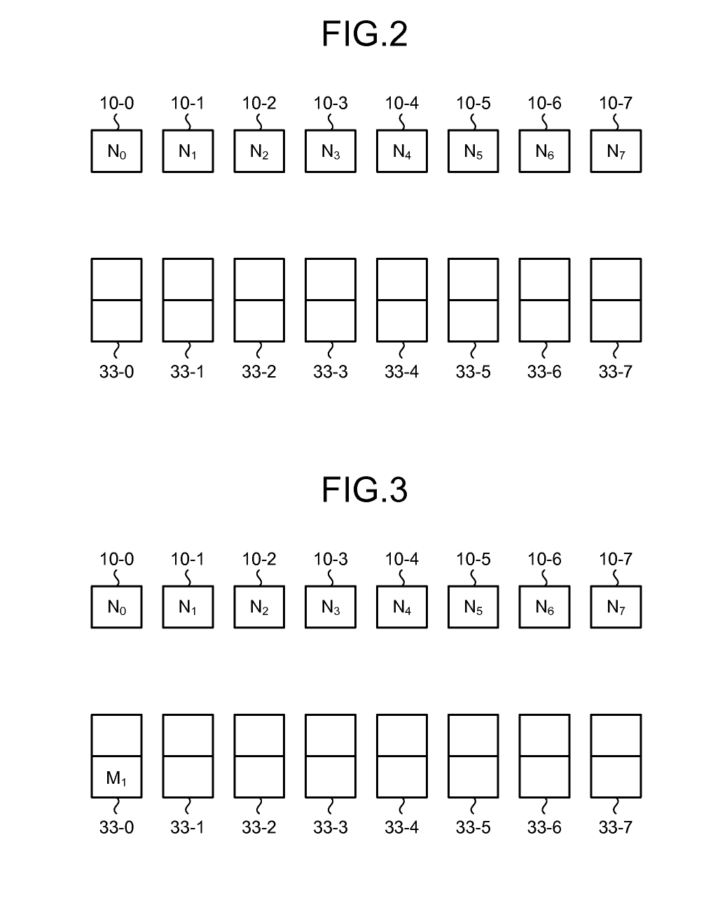

Hereinafter, a specific example for cancelling the transmission of a message will be described with reference to FIGS. 2 to 21. In the example shown in FIGS. 2 to 21, eight nodes, i.e., nodes N₀ 10-0 to N₇ 10-7, are arranged in a straight line as shown in FIG. 2 to establish a wireless mesh network.

Each of the nodes N₀ 10-0 to N₇ 10-7 is considered to have the configuration of the node 10 described above. The transmission message memories 33-0 to 33-7 denote the transmission message memories of the nodes N₀ 10-0 to N₇ 10-7, respectively. The transmission message memories 33-0 to 33-7 herein are queues capable of storing two messages, but the transmission message memories 33-0 to 33-7 are not limited thereto.

The node N₀ 10-0 is a node for broadcasting the original message and broadcasts a message with any given timing. When the nodes N₁ 10-1 to N₇ 10-7 receive the message, they broadcast the received message, whereby the nodes N₁ 10-1 to N₇ 10-7 transfers the message.

Each of the nodes N₀ 10-0 to N₇ 10-7 can perform wireless communication over a distance as far as three nodes in the right and left directions. Therefore, for example, the node N₀ 10-0 can wirelessly communicate with the nodes N₁ 10-1 to N₃ 10-3, and the node N₃ 10-3 can wirelessly communicate with the nodes N₀ 10-0 to N₂ 10-2 and N₄ 10-4 to N₆ 10-6.

Hereinafter, explanation will be given as an example where k=1 holds.

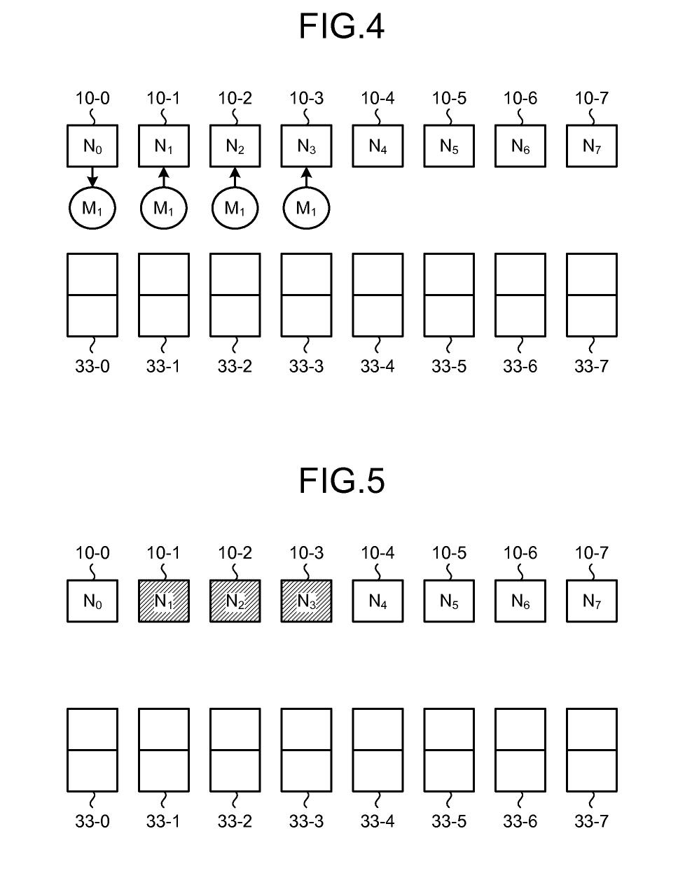

First, as shown in FIG. 3, transmission of a message M₁ is reserved in the transmission message memory 33-0 of the node N₀ 10-0. At a broadcast time slot, the node N₀ 10-0 broadcasts the message M₁ as shown in FIG. 4, and the nodes N₁ 10-1 to N₃ 10-3 receive the message M₁.

Subsequently, as shown in FIG. 5, each of the nodes N₁ 10-1 to N₃ 10-3 determines a waiting time s and activates a timer for counting the interval t.

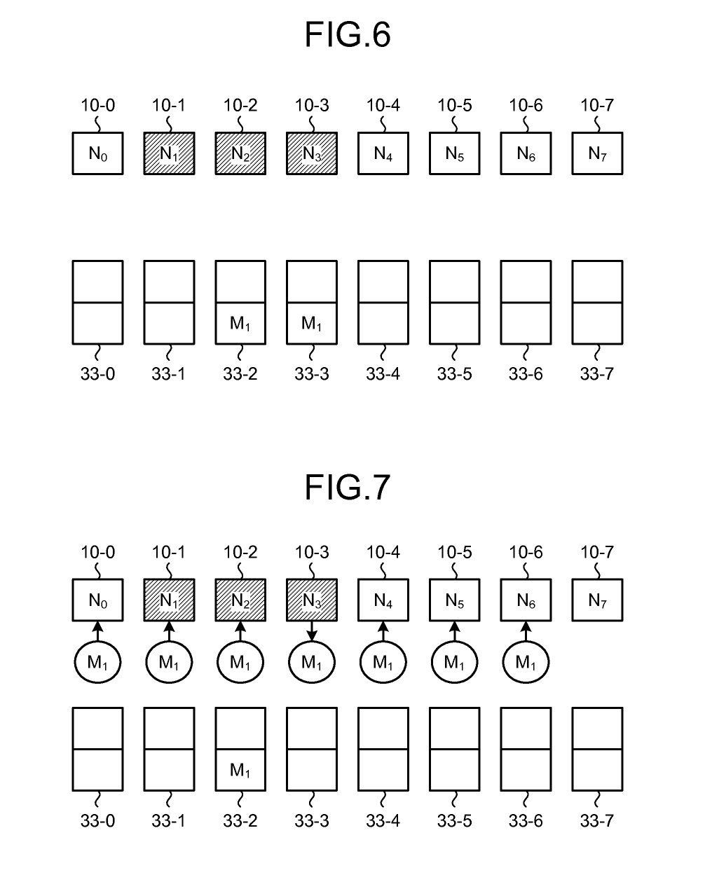

Subsequently, as shown in FIG. 6, because each of the nodes N₂ 10-2 and N₃ 10-3 has not received a message consistent with the message M₁ before the waiting time s, transmission of a message M₁ is reserved in the transmission message memories 33-2 and 33-3.

Then, at a broadcast time slot, the node N₃ 10-3 broadcasts the message M₁ as shown in FIG. 7, and the nodes N₀ 10-0 to N₂ 10-2 and N₄ 10-4 to N₆ 10-6 receive the message M₁.

In this case, both of the nodes N₂ 10-2 and N₃ 10-3 can broadcast the message M₁. However, as a result of Clear Channel Assessment (CCA), a Multicast channel is allocated to the node N₃ 10-3 at a point in time earlier than the node N₂ 10-2, and therefore, the node N₃ 10-3 broadcasts the message M₁. The CCA is a well-known technique and is not within the gist of the present embodiment, the detailed description about CCA is not included herein.

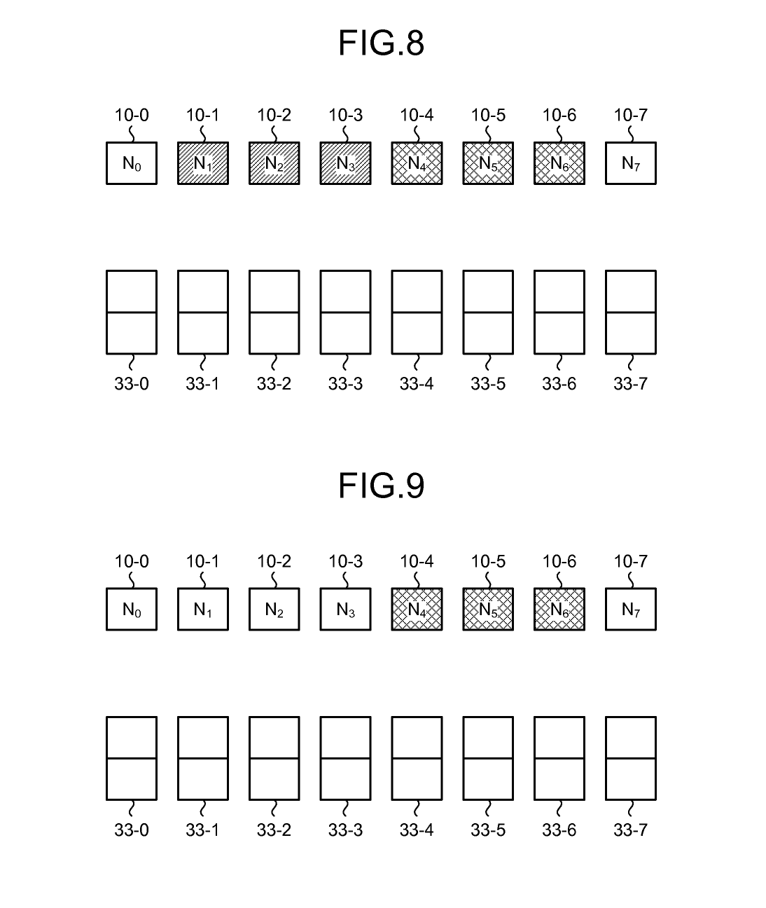

Subsequently, as shown in FIG. 8, the node N₁ 10-1 has the timer being active to count the interval t, the waiting time s has not elapsed, the message M₁ received from the node N₃ 10-3 is a message consistent with the message M₁ received from the node N₀ 10-0, and k=1 holds. Therefore, the node N₁ 10-1 does not reserve the transmission of the message M₁ received from the node N₀ 10-0.

The node N₁ 10-1 has the timer being active to count the interval t, the message M₁ received from the node N₃ 10-3 is a message consistent with the message M₁ received from the node N₀ 10-0, k=1 holds, and accordingly the above condition (2) is satisfied. Therefore, the node N₁ 10-1 deletes the message M₁ stored in the transmission message memory 33-2, and cancels the transmission of the message M₁.

Each of the nodes N₄ 10-4 to N₆ 10-6 determines a waiting time s, and activates a timer for counting the interval t.

Subsequently, as shown in FIG. 9, the interval t of N₁10-1 to N₃10-3 has passed, and the operation of the timer is terminated.

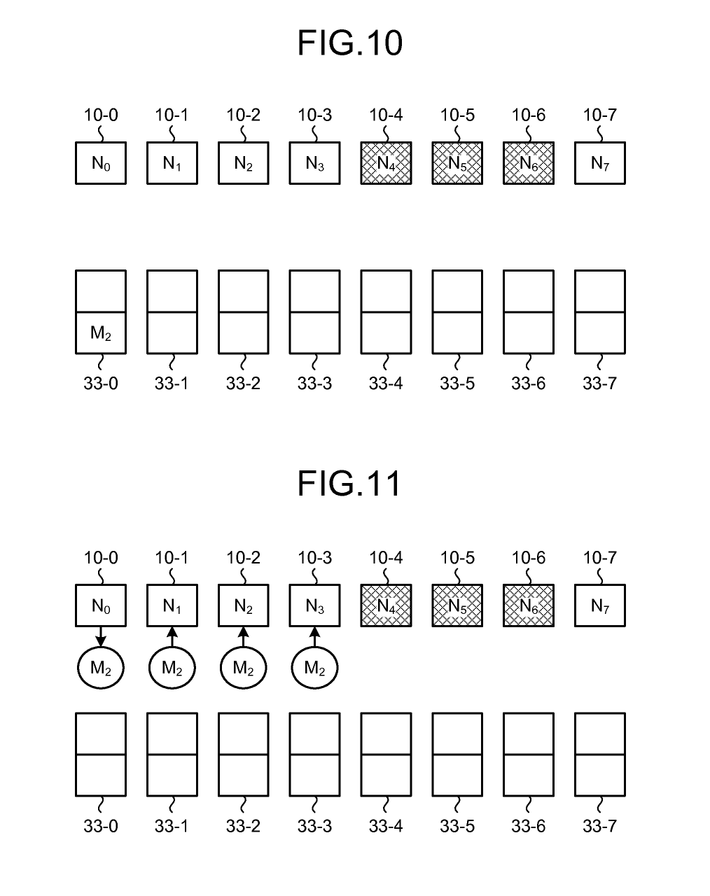

Subsequently, as shown in FIG. 10, the transmission of the message M₂ is reserved in the transmission message memory 33-0 of the node N₀ 10-0. At a broadcast time slot, the node N₀ 10-0 broadcasts the message M₂ as shown in FIG. 11, and the nodes N₁ 10-1 to N₃ 10-3 receives the message M₂. The message M₂ is a message newer than the message M₁.

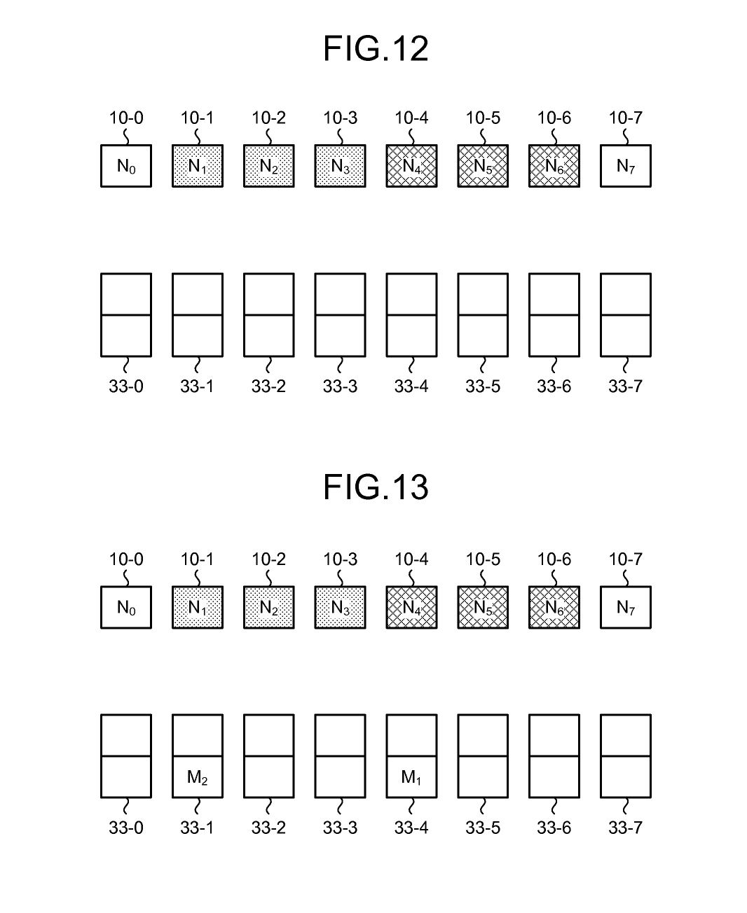

Subsequently, as shown in FIG. 12, each of the nodes N₁ 10-1 to N₃ 10-3 determines a waiting time s, and activates a counter for counting the interval t.

Subsequently, as shown in FIG. 13, as the node N₁ 10-1 has not received a message consistent with the message M₂ before the waiting time s, the transmission of the message M₂ is reserved in the transmission message memory 33-1. As the node N₄ 10-4 has not received a message consistent with the message M₁ before the waiting time s, the transmission of the message M₁ is reserved in the transmission message memory 33-4.

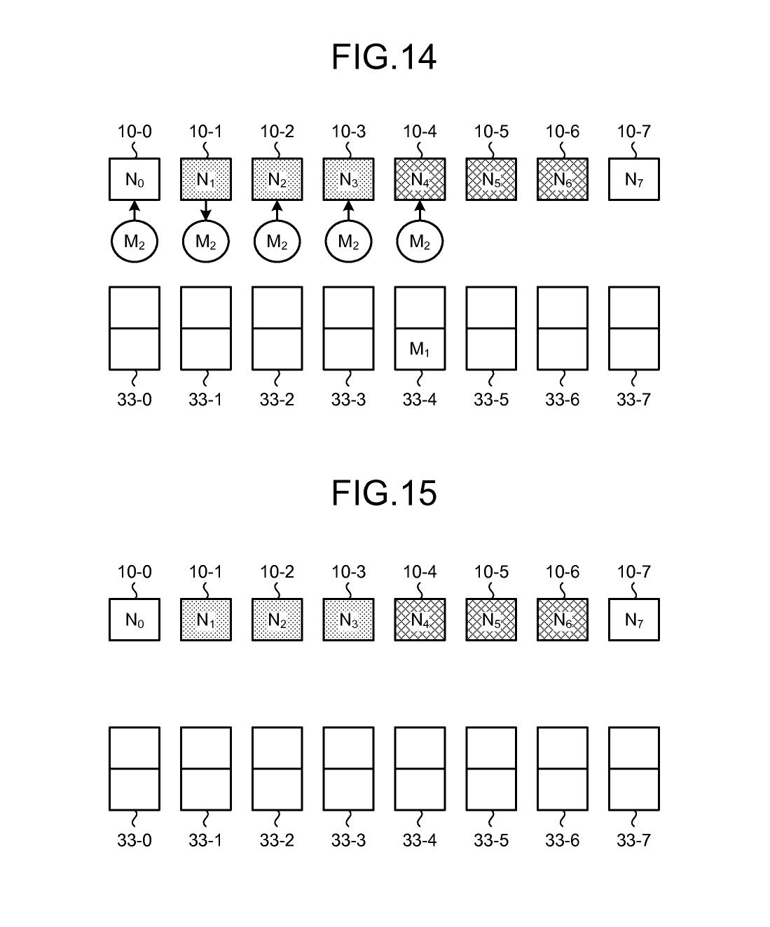

Then, at a broadcast time slot, as shown in FIG. 14, the node N₁ 10-1 broadcasts the message M₂, and the nodes N₀ 10-0 and N₂ 10-2 to N₄ 10-4 receive the message M₂.

In this case, N₁10-1 can broadcast the message M₂, and the node N₄ 10-4 can broadcast the message M₁. However, as a result of CCA, a Multicast channel is allocated to the node N₁ 10-1 at a point in timer earlier than the node N₄ 10-4, and therefore the node N₁ 10-1 broadcasts the message M₂.

Subsequently, as shown in FIG. 15, the nodes N₂ 10-2 and N₃ 10-3 have the timer being active to count the interval t, the waiting time s has not elapsed, the message M₂ received from the node N₁ 10-1 is a message consistent with the message M₂ received from the node N₀ 10-0, and k=1 holds. Therefore, the nodes N₂ 10-2 and N₃ 10-3 do not reserve the transmission of the message M₂ received from the node N₀ 10-0.

The node N₄ 10-4 has the timer being active to count the interval t, the message M₂ received from the node N₁ 10-1 is a message newer than the message M₁ received from the node N₃ 10-3, and accordingly the above condition (3) is satisfied. Therefore, the node N₄ 10-4 deletes the message M₁ stored in the transmission message memory 33-4, and cancels the transmission of the message M₁.

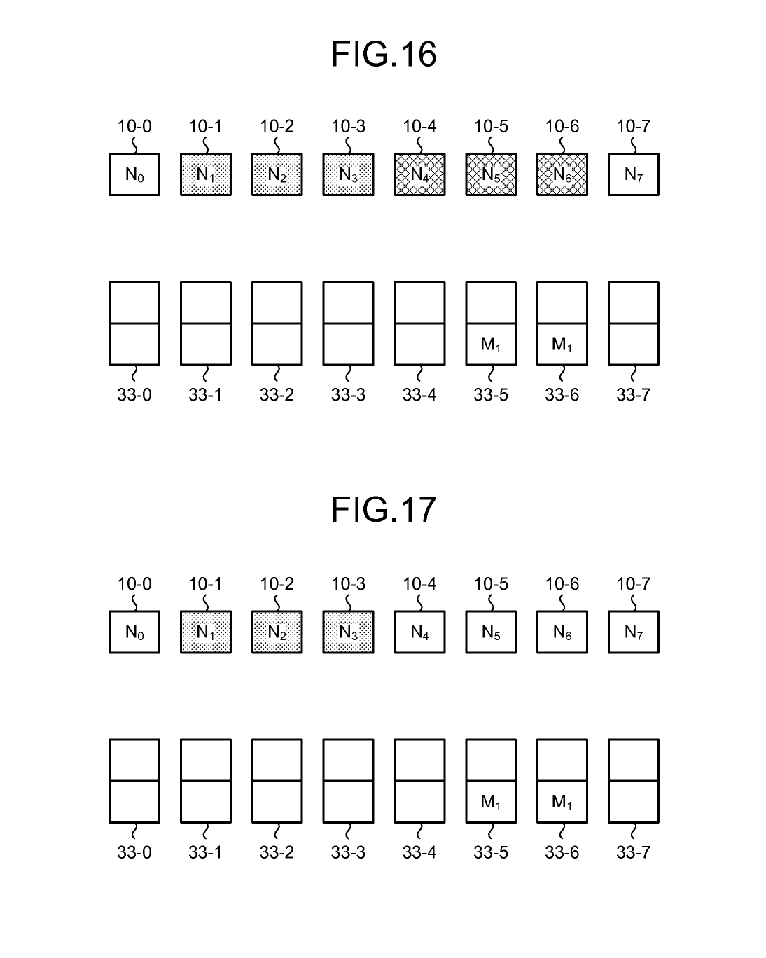

Subsequently, as shown in FIG. 16, each of the nodes N₅ 10-5 and N₆ 10-6 has not received a message consistent with the message M₁ before the waiting time s, and therefore, the transmission of the message M₁ is reserved in the transmission message memories 33-5 and 33-6.

Then, at a broadcast time slot, although at least any one of the nodes N₅ 10-5 to N₆ 10-6 is supposed to broadcast the message M₁, it is, in this case, assumed that none of the nodes N₅ 10-5 to N₆ 10-6 broadcasts the message M₁ because the Multicast channel is not available due to another communication.

Subsequently, as shown in FIG. 17, the interval t of the nodes N₄ 10-4 to N₆ 10-6 passes, and the operation of the timer is terminated.

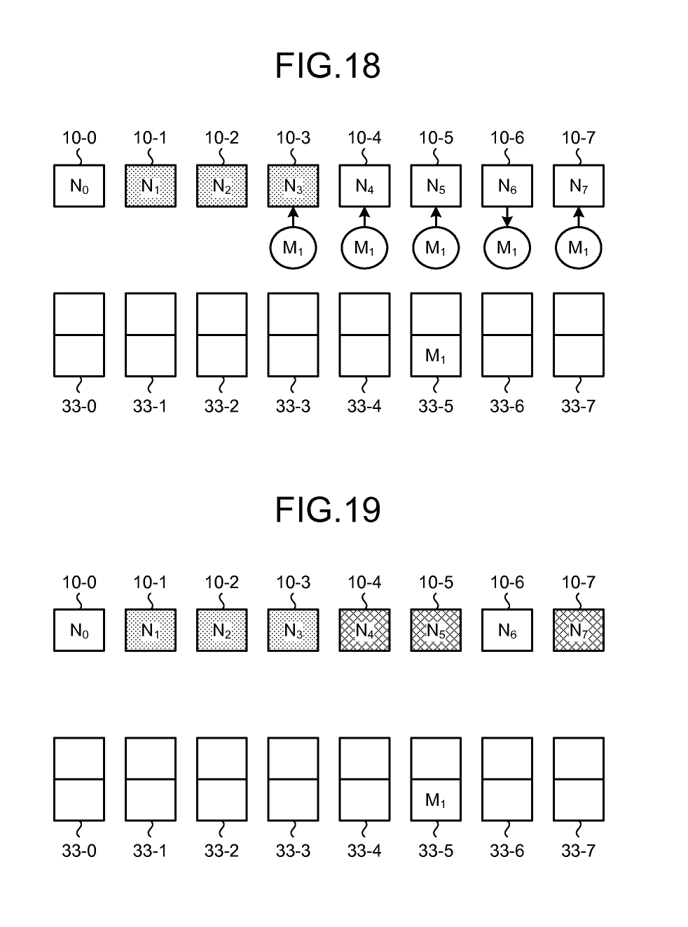

Subsequently, at a broadcast time slot again, the node N₆ 10-6 broadcasts the message M₁ as shown in FIG. 18, and the nodes N₃ 10-3 to N₅ 10-5 and N₇ 10-7 receive the message M₁.

In this case, both of the nodes N₅ 10-5 and N₆ 10-6 can broadcast the message M₁. However, as a result of CCA, a Multicast channel is allocated to the node N₆ 10-6 at a point in time earlier than the node N₅ 10-5, and therefore, the node N₆ 10-6 broadcasts the message M₁.

Subsequently, as shown in FIG. 19, each of the nodes N₄ 10-4 to N₅ 10-5 and N₇ 10-7 determines a waiting time s, and activates a timer for counting the interval t. The nodes N₄ 10-4 has already received the message M₁, and therefore, this processing may be omitted.

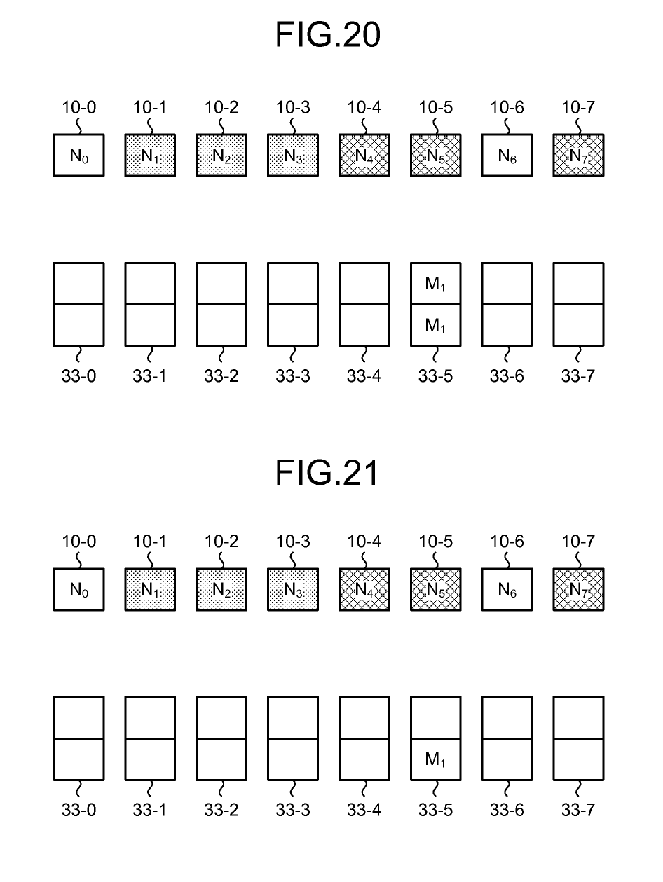

Subsequently, as shown in FIG. 20, as the node N₅ 10-5 has not received a message consistent with the message M₁ before the waiting time s, the transmission of the message M₁ is reserved in the transmission message memory 33-5.

As a result, as shown in FIG. 21, the transmission message memory 33-5 stores two messages M₁, and the above (1) condition is satisfied. Therefore, the node N₅ 10-5 deletes the message M₁ stored in the transmission message memory 33-5, and cancels the transmission of the message M₁.

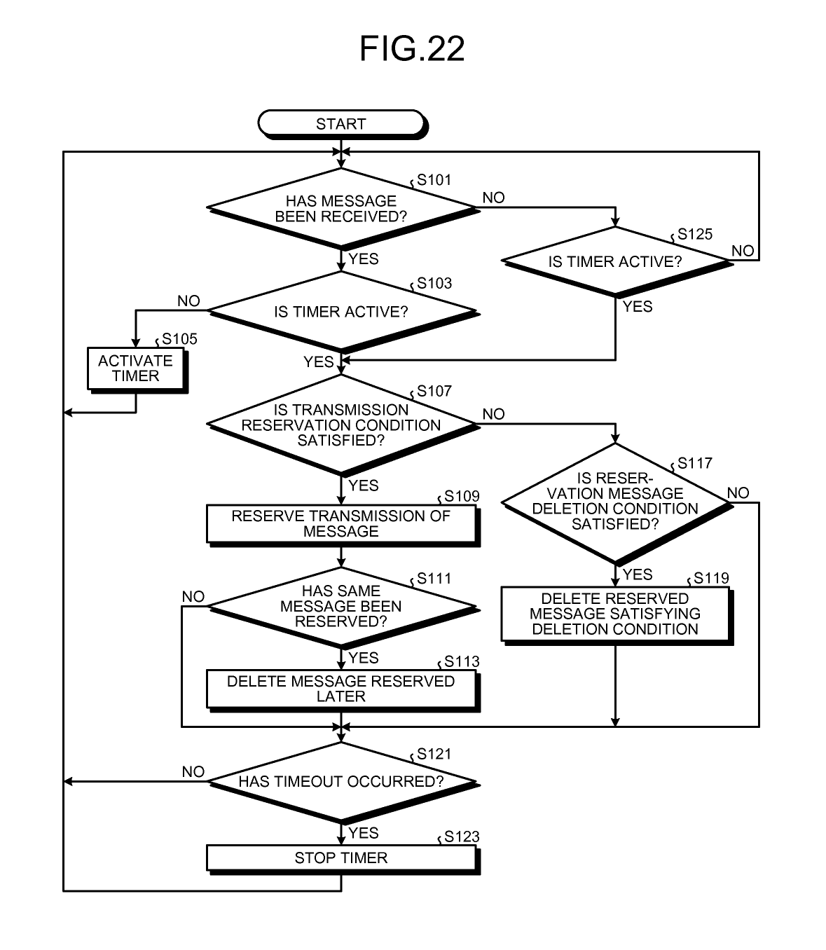

FIG. 22 is a flowchart illustrating an example of a flow of a process procedure performed by the node 10 of the first embodiment

First, the message receiver 21 receives a message supporting the Trickle Multicast stored in the reception message memory 31. When the message is handed over to the first manager 23 (Yes in step S101) and the first manager 23 has not activated the timer for counting the interval t (No in step S103), the waiting time s is determined and the timer for counting the interval t is activated (step S105). Subsequently, the flow returns to step S101.

When the first manager 23 has activated the timer for counting the interval t (Yes in step S103) and the transmission reservation condition is satisfied, and more specifically, when a message consistent with the received message is not given from the message receiver 21 for k times before the waiting time s (Yes in step S107), the message transmitter 25 is instructed to transmit a first given message (a message that triggered the setting of the interval t). The message transmitter 25 then stores the message, which is instructed by the first manager 23 to transmit, to the transmission message memory 33, and the transmission of the message instructed by the first manager 23 to transmit is reserved (step S109).

Subsequently, the second manager 27 determines whether the same message is reserved or not. More specifically, the second manager 27 determines whether the above condition (1) is satisfied (step S111). When the above condition (1) is satisfied (Yes in step S111), a message, out of the same messages, reserved to be transmitted at a later point in time series is deleted from the transmission message memory 33 and the transmission is cancelled (step S113).

On the other hand, when the transmission reservation condition is not satisfied (No in step S107), the second manager 27 determines whether a reservation message deletion condition is satisfied or not, and more specifically, the above condition (2) or (3) is satisfied or not (step S117). When the above condition (2) or (3) is satisfied (Yes in step S117), a message satisfying the deletion condition is deleted from the transmission message memory 33 and the transmission is cancelled (step S119).

Subsequently, in the first manager 23, the timer counts the interval t, and a determination is made as to whether a timeout occurs (step S121). When the timeout is determined to have occurred (Yes in step S121), the timer is stopped (step S123) and, subsequently, the flow returns to step S101. When the timeout is determined not to have occurred (No in step S121), the timer is not stopped and, subsequently, the flow returns to step S101.

When the message receiver 21 has not received a message corresponding to the Trickle Multicast stored in the reception message memory 31 in step S101 (No in step S101) and the first manager 23 has not activated the timer for counting the interval t (No in step S125), step S101 is performed again. When the first manager 23 has activated the timer for counting the interval t (Yes in step S125), step S107 is subsequently performed.

As described above, according to the first embodiment, even in an environment where the broadcast timing of the message randomly set by each node according to the Trickle Multicast are collected in a broadcast time slot by TSCH and there occurs many collisions of transmissions of messages, transmission of an unnecessary message is cancelled. Therefore, transmission of an unnecessary message can be avoided.

### Second Embodiment

In a second embodiment, an example where an interval t is counted in a broadcast time slot will be described. In the following description, the differences from the first embodiment will be mainly described. Constituent elements having the same functions as those of the first embodiment will be denoted with the same names and reference numerals as those of the first embodiment, and description thereof will not be repeated.

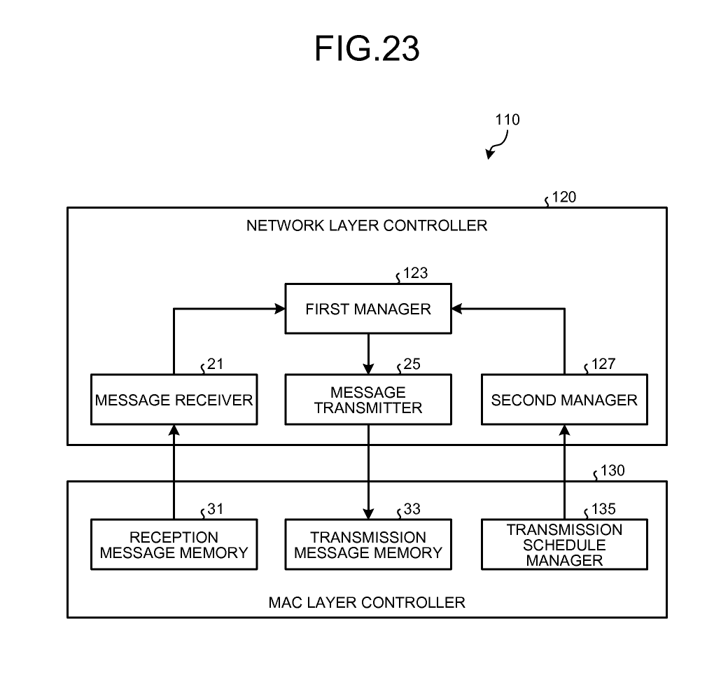

FIG. 23 is a configuration diagram illustrating an example of a node 110 according to the second embodiment. As shown in FIG. 23, the node 110 is different from the node of the first embodiment in terms of including a first manager 123 and a second manager 127 of a NETWORK layer controller 120 as well as a transmission schedule manager 135 of a MAC layer controller 130.

The transmission schedule manager 135 manages the schedule of the time slot allocated by the TSCH, and notifies the second manager 127 of the schedule.

The second manager 127 controls a timer for counting the interval t, which is controlled by the first manager 23 in the first embodiment. More specifically, the second manager 127 activates the timer and counts the interval t during a broadcast time slot in accordance with the schedule of the time slot notified by the transmission schedule manager 135.

For example, in a case of a schedule in which there is a broadcast time slot of 100 milliseconds in two seconds, the second manager 127 activates the timer during the broadcast time slot of 100 milliseconds. In this case, of course, the advancement of the timer is at a speed which is one twentieth of the actual time, and therefore, performance almost close to the ordinary Trickle Multicast can be achieved by setting a waiting time s, an interval t, and the like to also about 1/20-th of the ordinary Trickle Multicast.

The first manager 123 performs the same processing as the first manager 23 of the first embodiment except the counting of the interval t.

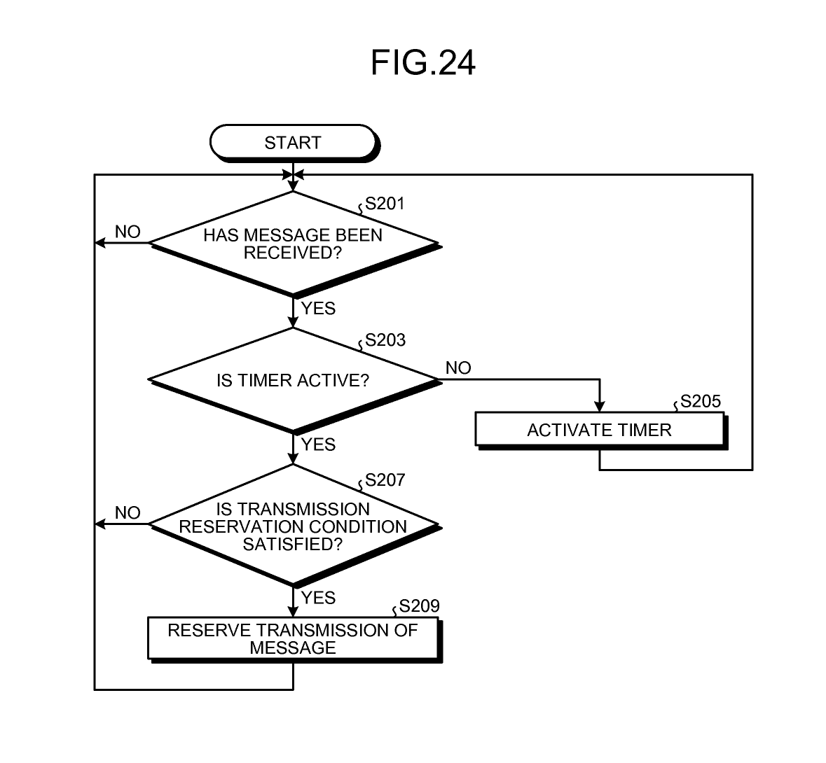

FIG. 24 is a flowchart illustrating an example of a flow of a process procedure of the first manager 123 performed by the node 110 of the second embodiment.

First, a message receiver 21 receives a message corresponding to the Trickle Multicast stored in a reception message memory 31. When the message is handed over to the first manager 123 (Yes in step S201) and the first manager 123 has a timer not being active (No in step S203), the first manager 123 causes the second manager 127 to activate the timer (step S205) and, subsequently, the flow returns to step S201.

When the first manager 123 has a timer being active (Yes in step S203) and a transmission reservation condition is satisfied, i.e., the first manager 123 does not receive a message consistent with the received message from the message receiver 21 for k times before the waiting time s (Yes in step S207), the first manager 123 instructs a message transmitter 25 to transmit the first received message (a message that triggered the setting of the interval t). The message transmitter 25 then stores the message, which is instructed by the first manager 123 to transmit, to a transmission message memory 33, and reserves the transmission of the message which is instructed by the first manager 123 to transmit (step S209). Subsequently, the flow returns to step S201.

When the transmission reservation condition is not satisfied (No in step S207), subsequently the flow returns to step S201.

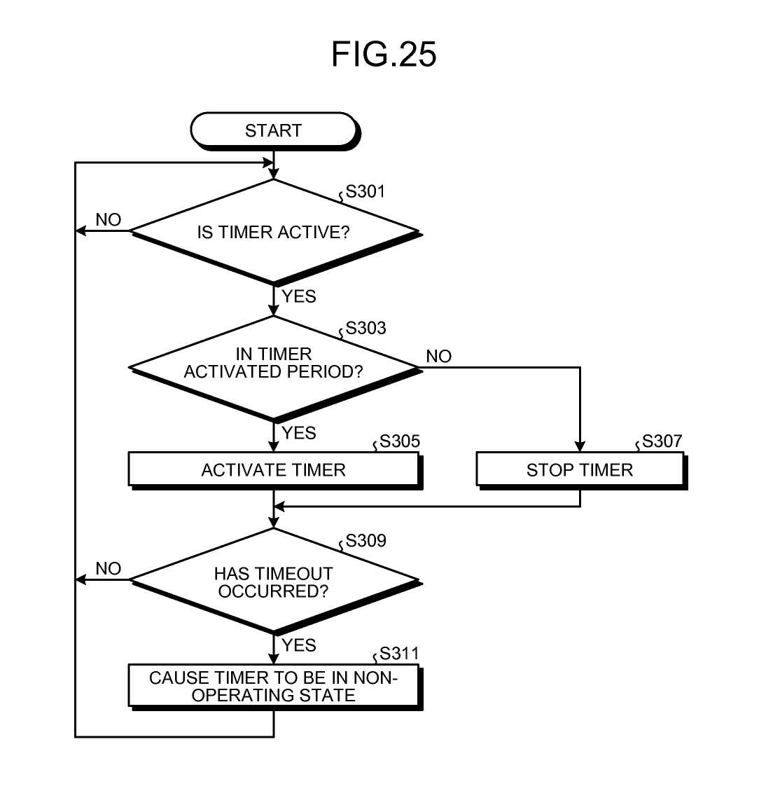

FIG. 25 is a flowchart illustrating an example of a flow of a process procedure of the second manager 127 performed by the node 110 of the second embodiment.

First, When the second manager 127 has a timer being active (Yes in step S301) and it is in the timer activated period, i.e., at a broadcast time slot (Yes in step S303), the second manager 127 activates the timer (step S305). When the second manager 127 is not at a broadcast time slot (No in step S303), the second manager 127 temporarily stops the timer (step S307). While the timer is temporarily at a stop, the state is treated as “activated state (Yes)” in S301, and the counting resumes from the state immediately before the temporary stop when the timer is activated in step S305.

Subsequently, the second manager 127 has the timer counting the interval t and determines whether a timeout occurs or not (step S309). When a timeout occurs (Yes in step S309), the timer is caused to be in a non-operating state (step S311) and, subsequently, the flow returns to step S301. When a timeout does not occur (No in step S309), the timer is not caused to be in a non-operating state and, subsequently, the flow returns to step S301.

As described above, according to the second embodiment, during the period of the broadcast time slot, i.e., a period in which a message can be broadcast, the timer for counting the interval t is active. Therefore, this can prevent the message transmission (transfer) timing of each node from being quantized with particular timing, and the same action as the ordinary Trickle Multicast can be performed. Consequently, according to the second embodiment, collision of transmission (transfer) of messages can be avoided, and a node that does not satisfy a transmission condition does not transmit a message, and therefore, transmission of an unnecessary message can be avoided.

Modification

In the first embodiment, the condition (2) may be “a case where the first manager 23 receives a message consistent with the message stored in the transmission message memory 33 from the message receiver 21 for k times”, and the condition (3) may be “a case where the first manager 23 receives a message newer than the message stored in the transmission message memory 33 from the message receiver 21”.

More specifically, even after the interval t passes, the transmission of a message may be cancelled. In this case, there may be a case where the condition (1) is not satisfied, and more specifically, there may be a case where the transmission message memory 33 does not include the same message. In such a case, the condition (1) may be deleted.

In each of the above embodiments, the broadcast based on the Trickle Multicast is used as an example and described; however, each of the above embodiments is not limited thereto, and it may also be possible to use a broadcast based on Multicast Protocol for Low-power and Lossy Network (MPL) defined by draft-ietf-trickle-mcast.

Each of the above embodiments may have an independent configuration, or may have a combined configuration.

Hardware Configuration

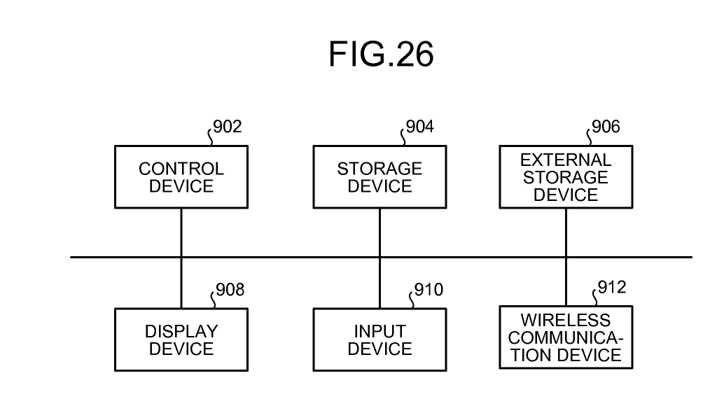

FIG. 26 is a block diagram illustrating an example of a hardware configuration of a node according to each of the above embodiments. As shown in FIG. 26, the node of each of the above embodiments includes a control device 902 such as a CPU, a storage device 904 such as a ROM and a RAM, an external storage device 906 such as an HDD and an SSD, a display device 908 such as a display, an input device 910 such as a keyboard or a mouse, and a wireless communication device 912 such as a wireless communication chip. The node has a hardware configuration using an ordinary computer.

A program executed by the node of each of the above embodiments is stored and provided in a computer-readable storage medium such as a CD-ROM, a CD-R, a memory card, a DVD, a flexible disk (FD), and the like in a file of an installable format or an executable format.

A program executed by the node of each of the above embodiments may be stored to a computer connected to a network such as the Internet, and may be provided by allowing the program to be downloaded via the network. A program executed by the node of each of the above embodiments may be provided or distributed via a network such as the Internet. A program executed by the node of each of the above embodiments may be provided by being incorporated into a ROM and the like in advance.

A program executed by the node of each of the above embodiments has a module configuration for achieving each unit described above on the computer. In actual hardware, for example, a CPU reads a program from a ROM to a RAM and executes the program, so that each of the above units is implemented on the computer.

As described above, according to each of the above embodiments, transmission of an unnecessary message can be avoided.

The execution order of the steps of the flowchart of the above embodiments may be changed, or multiple steps may be carried out at a time, or the steps may be carried out in an order different for each embodiment as long as it is not against the characteristics of the above embodiments.

Others

A transmission cancellation method includes: setting, when a broadcast message is received, a waiting time randomized within a predetermined interval; reserving, in a case where a message which is deemed to be the same as the received message is not received for a predetermined number of times until the waiting time passes, transmission of the message by broadcasting, but not reserving, in a case where the message is received for the predetermined number of times, the transmission of the message by broadcasting; and cancelling the transmission of any one of the messages, in a case where the message of which transmission is reserved is broadcast with timing of a broadcast time slot and the same message as the message of which transmission is reserved is reserved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transmission cancellation method, comprising:
setting, when a broadcast message is received, a waiting time randomized within a predetermined interval;
reserving, in a case where a message which is deemed to be the same as the received message is not received for a predetermined number of times until the waiting time passes, transmission of the message by broadcasting, but not reserving, in a case where the message is received for the predetermined number of times, the transmission of the message by broadcasting; and
cancelling the transmission of the message of which transmission is received, in a case where the message of which transmission is reserved is broadcast with timing of a broadcast time slot and a message which is deemed to be the same as the message of which transmission is reserved is received for the predetermined number of times.

2. The method according to claim 1, wherein Trickle Multicast or Multicast Protocol for Low-power and Lossy Network is used for broadcasting of the message.

3. The method according to claim 1, wherein the time slot is a time slot allocated using Time-Slotted Channel Hopping.

4. A transmission cancellation method, comprising:
setting, when a broadcast message is received, a waiting time randomized within a predetermined interval;
reserving, in a case where a message which is deemed to be the same as the received message is not received for a predetermined number of times until the waiting time passes, transmission of the message by broadcasting, but not reserving, in a case where the message is received for the predetermined number of times, the transmission of the message by broadcasting; and
cancelling the transmission of the message of which transmission is reserved, in a case where the message of which transmission is reserved is broadcast with timing of a broadcast time slot and a message newer than the message of which transmission is reserved is received.

5. The method according to claim 4, wherein Trickle Multicast or Multicast Protocol for Low-power and Lossy Network is used for broadcasting of the message.

6. The method according to claim 4, wherein the time slot is a time slot allocated using Time-Slotted Channel Hopping.

7. A transmission method, comprising:
setting, when a broadcast message is received, a waiting time randomized within a predetermined interval;
reserving, in a case where a message which is deemed to be the same as the received message is not received for a predetermined number of times until the waiting time passes, transmission of the message by broadcasting; but not reserving, in a case where the message is received for the predetermined number of times, the transmission of the message by broadcasting; and
measuring, in a case where the message of which transmission is reserved is broadcast with timing of a broadcast time slot, the waiting time during the broadcast time slot.

8. The method according to claim 7, wherein Trickle Multicast or Multicast Protocol for Low-power and Lossy Network is used for broadcasting of the message.

9. The method according to claim 7, wherein the time slot is a time slot allocated using Time-Slotted Channel Hopping.
